(19) United States
(12) Patent Application Publication
(10) Pub. No.: US 2010/0138618 A1
(43) Pub. Date: Jun. 3, 2010

(54) Priority Encoders

(75) Inventor: Steven Leeland, Scottsdale, AZ (US)

Correspondence Address: HENNEMAN & ASSOCIATES, PLC, 70 N. MAIN ST., THREE RIVERS, MI, 49093, US

(73) Assignee: VNS PORTFOLIO LLC, Cupertino, CA (US)

(21) Appl. No.: 12/327,736

(22) Filed: Dec. 3, 2008

(51) Int. Cl. G06F 12/00

(52) U.S. Cl. 711/158; 711/E12.001

(57) ABSTRACT

A priority encoder and a processing device having the priority encoder. The priority encoder includes a port selector for generating a plurality of prioritized read requests based on a plurality of write requests from a plurality of processing devices and a predetermined priority assigned to each of the plurality of processing devices, one of the plurality of processing devices being selected based on the plurality of prioritized read requests; and a port latch for holding the values of the prioritized read requests to enable one of a plurality of communication ports unless the prioritized read requests are changed, each communication port for communicating with one of the processing devices to read data from the processing device.

### COPYRIGHT STATEMENT

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The present invention relates to priority encoders, and is particularly concerned with assigning priority to a plurality of processing devices.

### BACKGROUND OF THE INVENTION

Referring to FIG. 1, a system is shown which includes an array of processing devices that are connected to each other by using a plurality of interconnecting buses. The computer array 100 has a plurality of processing devices 105aa, 105ab, 105ac through 105an in first row, 105ba, 105bb, 105bc through 105bn in second row, 105ca, 105cb, 105cc through 105cn in third row, and 105ma, 105mb, 105mc through 105nm in the row m. Each of the processing devices (105aa through 105nm) are connected to each other by a plurality of bidirectional data bus 110 which are explained in further detail in FIG. 2. One skilled in the art will recognize that there may be additional components in the computer array 100 that are excluded from the view of FIG. 1 for the sake of clarity. For example, as shown in FIG. 1 the processing device 105bb is connected to the processing devices 105ab, 105ba, 105bc and 105cb orthogonally and to processing devices 105aa, 105ac, 105ca and 105cc diagonally. Conflicts relating to multiple write and read requests are unavoidable, when more than one of the processing device communicates and sends a write request to the processing device 105bb at the same time. As such, requests to the processing device 105bb tend to accumulate, simultaneous write requests exemplify the problem, since it is clear that choices must be made between the several write requests. The processing device 105bb should choose between one of those requests to prevent a system crash. Thus, pending read and write requests should generally be prioritized so that the most urgent request is answered first.

FIG. 2 is a more detailed view of a portion of FIG. 1, showing only some of the processing devices in the computer array 100 and in particular, processing devices 105a through 105i. The view of FIG. 2 also reveals that the data buses 110 each have a read line, a write line and a plurality of data lines (a thick line is used to demonstrate the plurality of data lines). In this embodiment, the read and write requests are communicated via a read line and a write line included in the communication bus interconnecting two processing devices. The processing core 105e is connected with multiple processing devices 105a, 105b, 105c, 105d, 105f, 105g, 105h and 105i, either orthogonally or diagonally using the write lines (205ae, 205be, 205ce, 205de, 205ef, 205eg, 205eh, and 205ei), read lines (210ae, 210be, 210ce, 210de, 210ef, 210eg, 210eh, and 210ei) and plurality of data lines (215ae, 215be, 215ce, 215de, 215ef, 215eg, 215eh, and 215ei) respectively. If more than one of the processing devices 105a, 105b, 105c, 105d, 105f, 105g, 105h and 105i sends a write request to the processing device 105e, reading data from more than one direction port can, in some circumstances, result in corruption of data, in particular when data from more than one interconnecting bus is simultaneously gated to the same register. The undesirable possibility of more than one direction port getting connected to a register can be prevented by including a priority circuit in the computers of the array, which can avoid simultaneous presentation of write requests to the direction ports of a computer.

In practice, some methods exist to prioritize read and write requests, but they typically involve a time-consuming process of binary encoding and decoding the binary output to evaluate the priority. For example, in the scenario shown in FIG. 2 where the processing device can receive more than one write request from the eight processing devices, an 8:3 priority bit encoder is used in the prior art systems. Depending on how many active requests are received, the processing device will generate a three bit binary output, and the three bit binary output needs to be decoded to enable only one of the neighbouring processing devices. This two-step process may add a significant delay to the response time of the processing device, especially when speed is considered as a critical performance parameter.

Thus, taking the limitations of the prior art systems into consideration, there remains a need for a priority encoder that can handle multiple write requests from the neighbouring processing devices.

### SUMMARY OF THE INVENTION

An object of the present invention is to provide a priority encoder to obviate or mitigate at least some of the aforementioned disadvantages.

In accordance with an aspect of the present invention, there is provided a priority encoder which includes a port selector for generating a plurality of prioritized read requests based on a plurality of write requests from a plurality of processing devices, and a predetermined priority assigned to each of the plurality of processing devices. One of the plurality of processing devices is selected based on the plurality of prioritized read requests. The priority encoder includes a port latch for holding the values of the prioritized read requests to enable one of a plurality of communication ports, unless the prioritized read requests are changed, for each communication port communicating with one of the processing devices to read data from the processing device.

In accordance with an aspect of the present invention, there is provided a processing device having the priority encoder having the port selector and the port latch.

Some apparatus for automatically identifying the processing device with highest priority from a plurality of processing devices trying to communicate with the same processor core at the same time is described.

In one embodiment, the apparatus includes a priority selector to monitor the active write requests from the neighbouring processing devices and determine the write request with highest priority. The apparatus also includes plurality of port latch circuits that are coupled to the priority selector and neighbouring devices through the communication ports. The plurality of port latch circuits are used to retain the values of the prioritized read requests at a given state unless one of the inputs changed.

### BRIEF DESCRIPTION OF THE DRAWINGS

The present invention will be further understood from the following detailed description with reference to the drawings in which:

FIG. 1 illustrates in a block diagram, a known computer array with multiple processing cores;

FIG. 2 illustrates in a block diagram, known processing devices interconnected to multiple processing devices using multiple data buses;

FIG. 3 illustrates in a block diagram, a processing system in accordance with an embodiment of the present invention;

FIG. 4 illustrates in a block diagram, the N-port priority encoder of FIG. 3;

FIG. 5 schematically illustrates an exemplary circuit diagram of the N port selector of FIG. 4;

FIG. 6 schematically illustrates an exemplary circuit diagram of the 4-port selector of FIG. 4; and,

FIG. 7 schematically illustrates an exemplary circuit diagram of one of the latches of the N port latch of FIG. 4.

### DETAILED DESCRIPTION OF THE PREFERRED EMBODIMENT

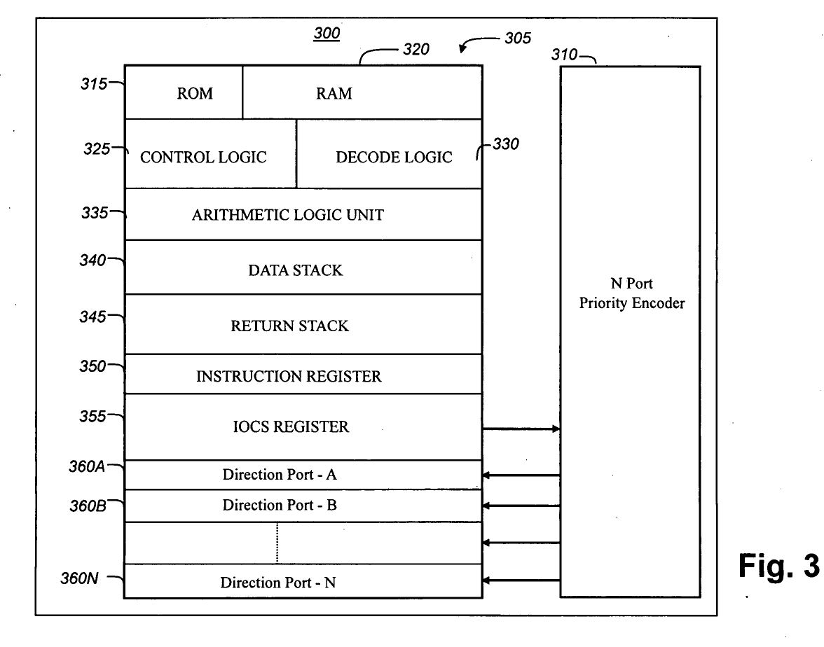

FIG. 3 illustrates a processing device 300, including a dual stack processor 305 coupled to N-port priority encoder 310 according to one embodiment of the proposed invention. The processing device 300 is, for example, used as an element of an array of multiple processing devices where the multiple processing devices are connected each other. The dual stack processor 305 is generally a self-contained computer, having its own RAM 315 and RAM 320. Other basic components of the dual stack processor 305 include a control logic circuit 325, a decode logic circuit 330, an arithmetic logic unit 335, a data stack 340, a return stack 345, an instruction register 350 and an inter-processor status register (IOCS) 355. The dual stack processor 305 also includes ‘N’ communication ports; Direction Port-A 360A, Direction Port-B 360B through Direction Port-N 360N via which the processor core 300 can communicate with neighbouring processing devices.

Each of Direction port-A 360A, Direction port-B 360B, through Direction port-N 360N is assigned to one of the processing devices that can send write requests to the processing device 300, as explained in detail below.

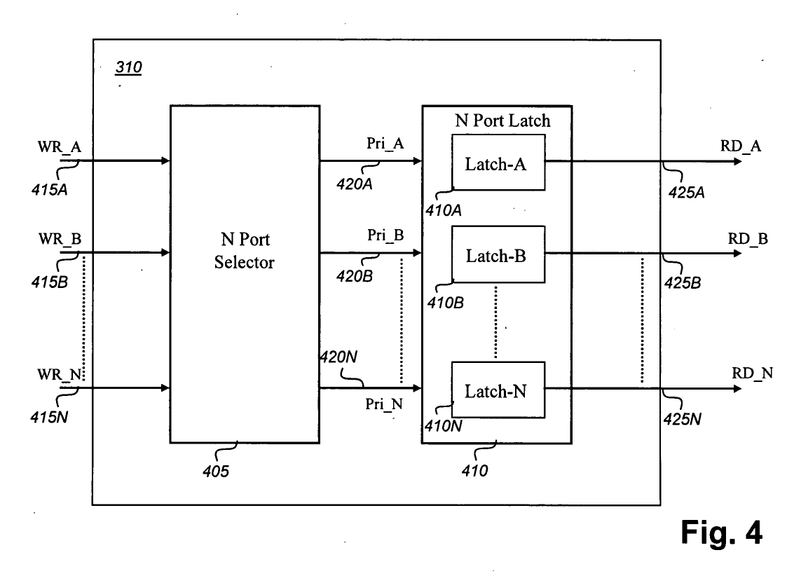

In one embodiment, the N-port priority encoder 310 monitors inter processor communication by reading the IOCS register 355 and determines one of the neighbouring processing devices to accept one write request from one of the neighbouring processing devices only, and activates the communication channel through one of the communication ports, Direction Port-A 360A, Direction Port-B 360B through Direction Port-N 360N, to read data from one of neighbouring processing devices. The functionality of the N-port priority encoder 310 is explained in further detail hereinbelow with reference to FIG. 4.

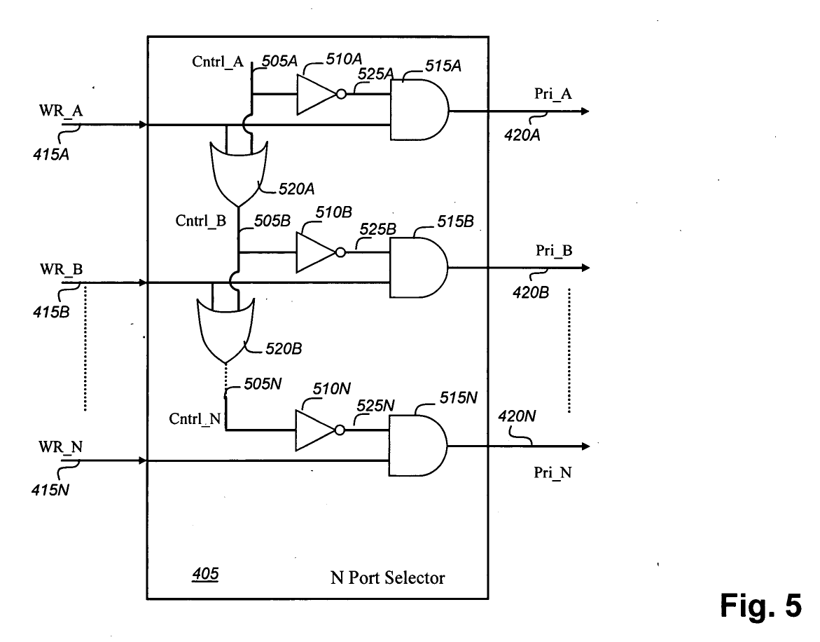

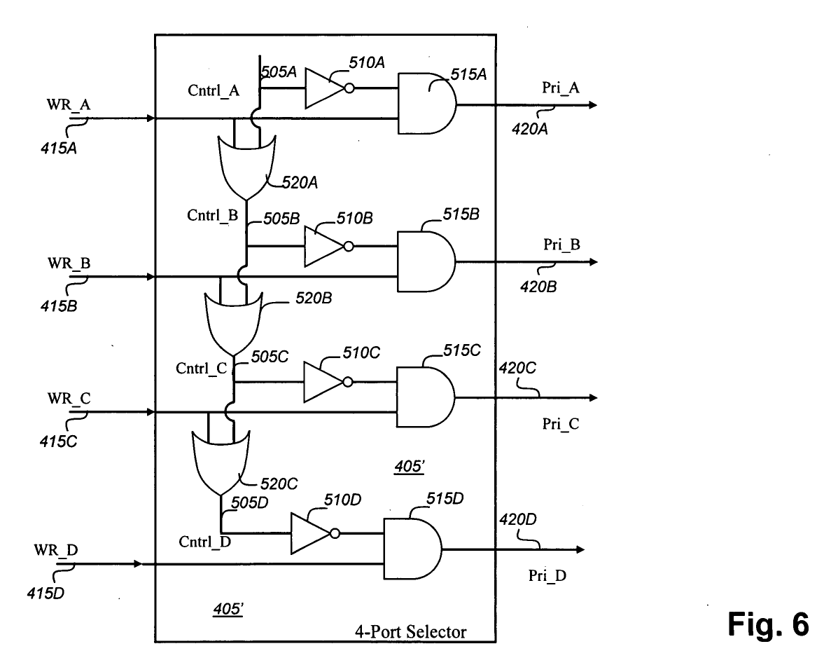

Referring to FIG. 4, the N-Port priority encoder 310 for N neighbouring processing devices are connected to one of the processing devices. The N-port priority encoder 310 includes an N-port selector 405 that is used to select one of the N multiple processing devices based on the predetermined priority and their write requests, and an N-port latch 410 having a series of N latches that are coupled to the N-port selector 405. The N-port selector 405 reads the write request bits WR_A, WR_B through WR_N (415A, 415B through 415N) respectively, from the IOCS register 355 and generates prioritized read requests Pri_A, Pri_B through Pri_N (420A, 420B through 420N) respectively. For example, if the processing device 300 receives four pending write requests from four multiple processing devices, the N-port selector 405 (in this case N is equal to four) provides a read request to one of the multiple processing devices with the highest priority. The CMOS circuit of the N-Port selector 405 is discussed in further detail hereinbelow with reference to FIG. 5. The N-port latch 410 is an array of N latches, Latch-A, Latch-B through Latch-N (410A, 410B through 410N) that receives prioritized read requests Pri_A, Pri_B through Pri_N (420A, 420B through 420N) from the N-port selector 405. The array of N latches, Latch-A, Latch-B through Latch-N (410A, 410B through 410N) are used to retain the values of the prioritized read requests Pri_A, Pri_B through Pri_N (420A, 420B through 420N) and provide outputs RD_A, RD_B through RD_N (425A, 425B through 425N). The CMOS design of the N-port latch 410 is explained in further detail hereinbelow with reference to FIG. 6.

Direction port-A 360A, Direction port-B 360B through Direction port-N 360N of FIG. 3 are connected to RD_A, RD_B through RD_N, respectively. RD_A, RD_B through RD_N determine the priority of Direction port-A 360A, Direction port-B 360B through Direction port-N 360N and thus determine which neighboring processing device can send data.

FIG. 5 illustrates an exemplary circuit diagram of the N-port selector 405. As shown in FIG. 5, the CMOS circuit design of the N-port selector 405 utilizes a series of AND and OR gates to generate prioritized read requests Pri_A, Pri_B through Pri_N (420A, 420B through 420N) based on the multiple write requests WR_A, WR_B through WR_N (415A, 415B through 415N) received from neighbouring processing devices. A series of AND gates (515A, 515B through 515N) receive inverted control bits (525A, 525B through 525N) and write requests WR_A, WR_B through WR_N (415A, 415B through 415N) and generate the prioritized read requests Pri_A, Pri_B through Pri_N (420A, 420B through 420N). A series of inverters (510A, 510B through 510N) are used to generate inverted values (525A, 525B through 525N) of selection control bits Cntrl_A, Cntrl_B through Cntrl_N (505A, 505B through 505N). The selection control bit Cntrl_A 505A is always fixed at a logical value of ‘0’. A series of OR gates (520A, 520B and so on) are utilized to generate the control bits Cntrl_B through Cntrl_N (505B through 505N) from the inputs Cntrl_A, Cntrl_B through Cntrl_N−1 (505A, 505B and so on) and write requests WR_A, WR_B through WR_N−1 (415A, 415B and so on) respectively. Cntrl_N−1 (not shown) is a selection control bit and is one of inputs provided to OR gate (not shown) for outputting Cntrl_N. WR_N−1 (not shown) is a write request bit and is an input to the OR gate for outputting Cntrl_N.

In FIG. 5, the N-port selector 405 includes N AND gates (515A, 515B through 515N), N inverters (510A, 510B through 510N), and N−1 0R gates (520A, 520B and so on) where N is the number of communication ports (360A, 360B through 360N of FIG. 3). Each of the N AND gates outputs a corresponding prioritized read request (e.g., Pri_A, Pri_B . . . ) based on an output from a corresponding inverter and a write request (e.g., WR_A, WR_B . . . ). The (N−1) OR gates generate selection control bits (e.g., Cntrl_B . . . ) except Cntrl_A.

Based on the predetermined priority, a communication port (e.g., 360B) with the highest priority is connected to AND gate 515A and OR gate 520A, a communication port (e.g., 360N) with the next highest priority is connected to AND gate 515B and OR gate 520B, and a communication port (e.g., 360A) with the lowest priority is connected to AND gate 515N and OR gate for generating Cntrl_N.

Referring to FIG. 6, there is schematically illustrated an exemplary circuit diagram of the 4-port selector 405. To simplify the description for explanation purposes, N is given a value of four, hence the 4-Port selector 405′ can receive a maximum of four write requests WR_A, WR_B, WR_C and WR_D (415A, 415B, 415C and 415D) from the multiple processing devices (e.g, 105A, 105B, 105C and 105D). Also, assume that the processing device 105A has the highest priority followed by the processing devices 105B, 105C and 105D (105A>105B>105C>105D). The different possible scenarios based on the active write requests of the multiple processing devices are classified into four scenarios, Condition-1, Condition-2, Condition-3 and Condition-4, as shown in Table 1.

A Condition-1 will occur when the write request WR_A 415A is active (logic value of ‘1’) and the logic state of the rest of the write requests WR_B, WR_C and WR_D (415B, 415C and 415D) can be active or inactive. Condition-2 is detected when the write request WR_A 415A is inactive (logic value of ‘0’) and WR_B 415B is active (logic value of ‘1’), and the logic state of the write requests WR_C and WR_D (415C and 415D) can be active or inactive. Condition-3 will occur when the write request WR_A and WR_B (415A and 415B) are inactive (logic value of ‘0’), WR_C 415C is active (logic value of ‘1’), and the logic state of the write request WR_D 415D can be active or inactive. Condition-4 is detected when the write request WR_A, WR_B and WR_C (415A, 415B and 415C) are inactive (logic value of ‘0’) and write request WR_D is active.

TABLE 1
Assumption: 105A > 105B > 105C > 105D

Write Requests

| | WR_A | WR_B | WR_C | WR_D |
|---|---|---|---|---|
| Condition-1 | Active | Don't care | Don't care | Don't care |
| Condition-2 | Inactive | Active | Don't care | Don't care |
| Condition-3 | Inactive | Inactive | Active | Don't care |
| Condition-4 | Inactive | Inactive | Inactive | Active |

TABLE 2

| Condition | Pri_A | Cntrl_B | Pri_B | Cntrl_C | Pri_C | Cntrl_D | Pri_D |
|---|---|---|---|---|---|---|---|
| Condition-1 | 1 | 1 | 0 | 1 | 0 | 1 | 0 |
| Condition-2 | 0 | 0 | 1 | 1 | 0 | 1 | 0 |
| Condition-3 | 0 | 0 | 0 | 0 | 1 | 1 | 0 |
| Condition-4 | 0 | 0 | 0 | 0 | 0 | 1 | 1 |

Table 2 shows the values of prioritized read requests and control bits based upon the conditions shown in Table 1. During Condition-1 the inputs to the first AND gate 515A are write request WR_A 415A of logic value ‘1’ and the inverted value of control bit Cntrl_A 510A of logic value ‘1’ (as mentioned earlier in FIG. 4, the value of control bit Cntrl_A 505A is fixed at logic value of ‘0’), the value of the prioritized read request Pri_A 420A is ‘1’. The inputs to the OR gate 520 A is the control bit Cntrl_A 505A of logic value ‘0’ and write request WR_A 415A, making the output control bit Cntrl_B 505B of logic value ‘1’. Applying the same logic as above, the inputs to the second AND gate 515B are write request WR_B 415B and the inverted value of control bit Cntrl_B 510B of logic value ‘0’, thus making the value of the prioritized read request Pri_B 420B ‘0’. One of the inputs (Cntrl_B 505B) to the successive OR gate 520B is a ‘1’, regardless of the logic value of WR_B 415B, the value of the control bit Cntrl_C 505C is ‘1’. Similarly, the inputs to the third AND gate 515C are write request WR_C 415C and the inverted value of control bit Cntrl_C 510C of logic value ‘0’, thus making the value of the prioritized read request Pri_C 420C ‘0’. One of the inputs (Cntrl_C 505C) to the successive OR gate 520B is a ‘1’, so regardless of the logic value of WR_C 415C the value of the control bit Cntrl_D 505D is ‘1’. Finally, the inputs to the last AND gate 515D are write request WR_D 415D and the inverted value of control bit Cntrl_D 510D of logic value ‘0’, thus making the value of the prioritized read request Pri_D 420D ‘0’. For one skilled in the art, it will be obvious from the above discussion that if the write request WR_A 415A from the processing device 105a with highest priority is active, the read request Pri_A 420A to that processing device 105a is activated, regardless of the state of the write requests from the rest of the processing devices. Applying the same logic, the outputs for the other conditions such as condition-2, condition-3 and condition-4, the same can be derived by one skilled in the art.

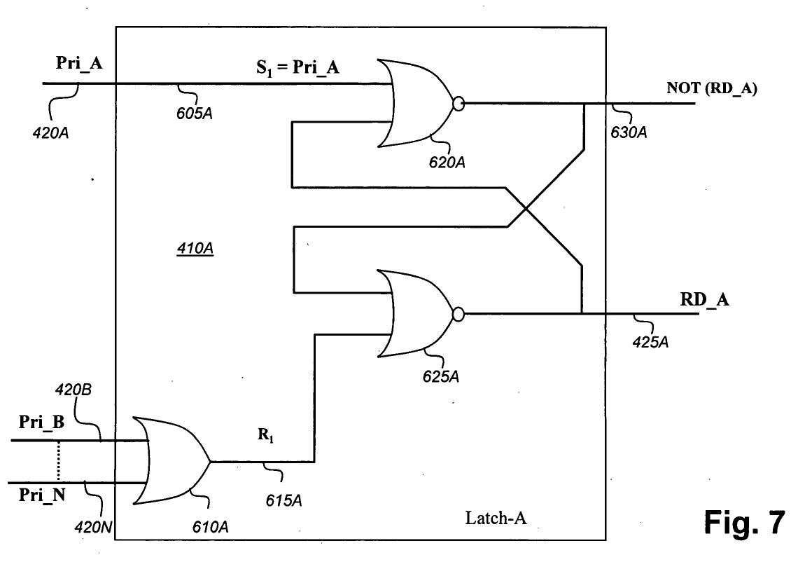

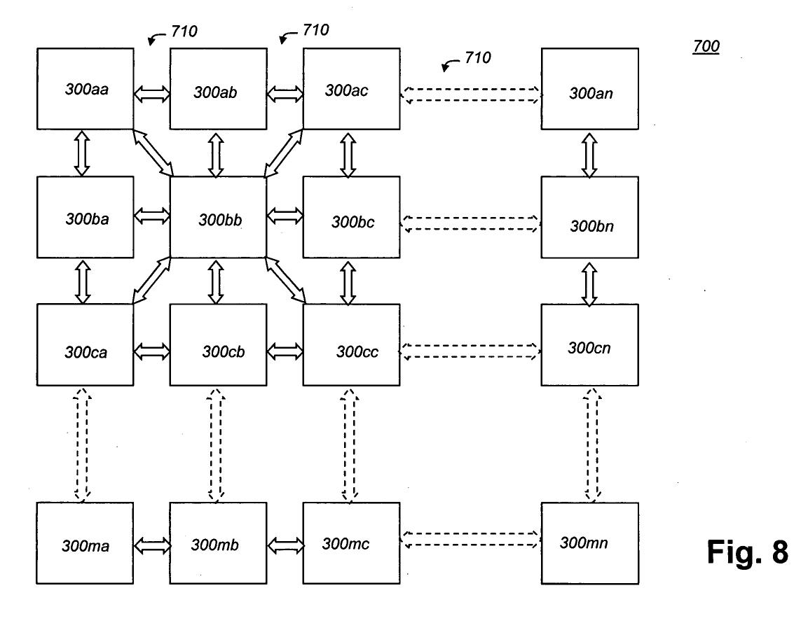

Referring to FIG. 7, there is illustrated embodiment of circuit diagram of the latch, Latch-A 410A of the array of the latches in the N Port Latch 410. The latch Latch-A 410A is a simple SR latch with the NOR gates 620A and 625A, which are cross coupled with each other and receive inputs S₁ 605A and Pri_A 420A, and input R₁ 615A, respectively. The input R₁ 615A is generated by ORing the prioritized read requests Pri_B through Pri_N (420B through 420N) using the OR gate 610A. If both the values of S₁ 605A and R₁ 615A are zero, the outputs of the latch RD_A 425A and NOT (RD_A) 630A remain unchanged. If the input value of S₁ 605A is a ‘0’ and the input value of the R1 615A is a ‘1’, then the output value of RD_A 425A becomes a ‘0’ and the output NOT (RD_A) 630A will be a ‘1’. If the input value of S₁ 605A is a ‘1’ and the input value of the R1 615A is a ‘0’, then the output value of RD_A 425A becomes a ‘1’ and the output NOT (RD_A) 630A will be a ‘0’. For S₁ 605A to be a ‘1’, the prioritized read request Pri_A 420A has to be a ‘1’ and for R₁ 615A to be a ‘1’, at least one of the prioritized read requests Pri_B through Pri_N (420B through 420N) has to be a ‘1’. For one skilled in the art, it is obvious that at any given time, only one of the prioritized read requests Pri_A through Pri_N (420A through 420N) can be at a logic value of ‘1’. Thus, using S₁ 605A and R₁ 615A as the inputs of the SR latch, where at most only one of them can be at a logic value of ‘1’, the unstable condition of the SR latch can be avoided. Similarly, inputs to Latch-B, S2 605B and R2 615B are Pri_B 420B and the output generated by ORing prioritized read requests Pri_A 420A and Pri_C through Pri_N (420C through 420N) the unstable condition of the SR latch can be avoided.

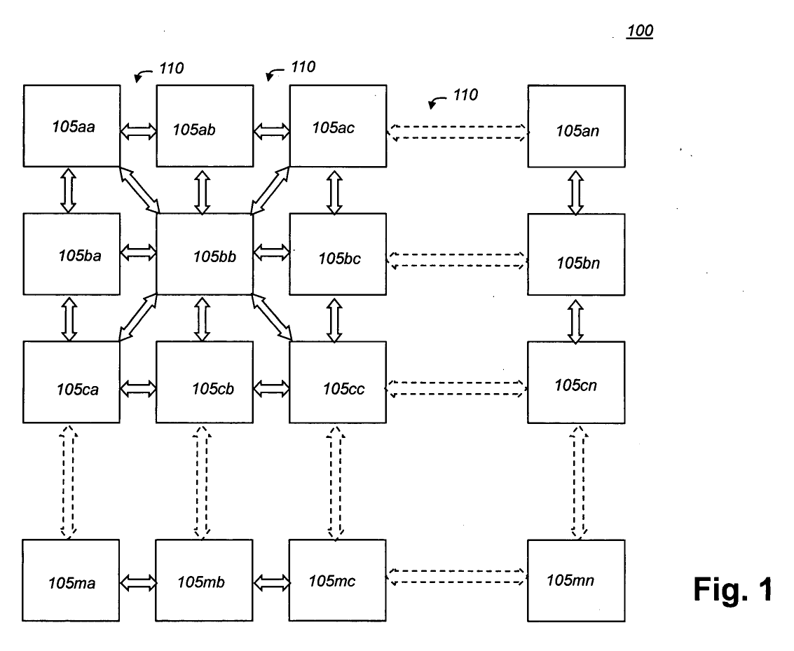

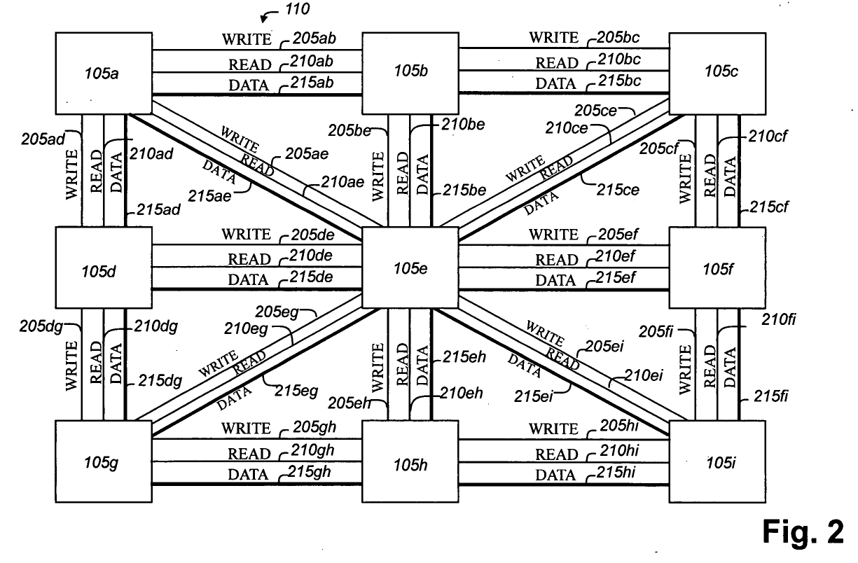

The processing device 300 of FIG. 3 can be used in the computer array of FIGS. 1-2 in which each of the processing devices (e.g., 105aa to 105nm of FIG. 1, 105a to 105i of FIG. 2) is replaced with the processing device 300. One skilled in the art will appreciate that the array structure for the processing device 300 of FIG. 3 is not limited to those of FIGS. 1-2.

Numerous modifications, variations and adaptations may be made to the particular embodiments described above without departing from the scope patent disclosure, which is defined in the claims.

What is claimed is:

1. A priority encoder, comprising:
a port selector for generating a plurality of prioritized read requests based on a plurality of write requests from a plurality of processing devices and a predetermined priority assigned to each of the plurality of processing devices, one of the plurality of processing devices being selected based on the plurality of prioritized read requests; and,
a port latch for holding the values of the prioritized read requests to enable one of a plurality of communication ports unless the prioritized read requests are changed, each communication port for communicating with one of the processing devices to read data from the processing device.

2. A priority encoder according to claim 1, wherein the port selector comprises:
a plurality of selection control bits for the plurality of processing devices, respectively; and,
a plurality of first gates for the plurality of processing devices, respectively, each for activating or inactivating the corresponding prioritized read request based on the corresponding write request and the corresponding selection control bit.

3. A priority encoder according to claim 2, wherein one of the selection control bits is set to a predetermined level during an operation of the priority encoder, and wherein each of one or more remaining selection control bits is changeable between a logic high and a logic low during the operation of the priority encoder.

4. A priority encoder according to claim 3, wherein each of the one or more remaining selection control bits is determined based on at least one of the write request from another processing device and another selection control bit.

5. A priority encoder according to claim 2, wherein one of the selection control bits is set to the predetermined level for the processing device having a predetermined highest priority.

6. A priority encoder according to claim 2, wherein the plurality of processing devices comprise:
a processing device having a predetermined highest priority;
one or more remaining processing devices, each having a different predetermined priority lower than the predetermined highest priority; and
wherein the plurality of selection control bits comprises:
a selection control bit for the processing device having the predetermined highest priority, the selection control bit for the processing communication port having the predetermined highest priority being set to a predetermined level during the operation of the priority encoder; and,
one or more remaining selection control bits for the one or more remaining processing devices, respectively, each being determined based on at least one of the write request from another processing device and another selection control bit.

7. A priority encoder according to claim 6, wherein the port selector comprises:
one or more second gates for the one or more remaining processing devices, respectively, each for generating the corresponding selection control bit based on another selection control bit for one processing device having a predetermined higher priority and the write request from the one processing device.

8. A priority encoder according to claim 7, wherein each of the one or more second gates is an OR gate.

9. A priority encoder according to claim 3, wherein each of the first gates is an AND gate.

10. A priority encoder according to claim 9, wherein the port selector comprises:
a plurality of inverters for the plurality of processing devices, respectively, each for receiving the corresponding selection control bit and outputting an inverted selection control bit to the corresponding first gate.

11. A priority encoder according to claim 1, wherein the port latch comprises:
a plurality of latches for the plurality of processing devices, respectively, each for retaining a current logic state of a corresponding prioritized read request output from the port selector and changing its logic state on detecting a change in the logic state of the plurality of prioritized read requests output from the port selector, the output of each of the latches being connected to the corresponding communication port.

12. A priority encoder according to claim 11, wherein each of the plurality of latches comprises:
a NAND latch having:
a first input for receiving the corresponding prioritized read request;
a second input; and
an OR gate for receiving one or more remaining prioritized read requests, the second input receiving the output from the OR gate.

13. A processing device having a priority encoder according to claim 1.
